(19) United States
(12) Patent Application Publication
(10) Pub. No.: US 2026/0094093 A1
(43) Pub. Date: Apr. 2, 2026

(54) SYSTEMS AND METHODS FOR MULTIFACTOR WORKFLOW PRIORITIZATION

(71) Applicant: Black Hills IP Holdings, LLC, Minneapolis, MN (US)

(72) Inventor: Steven W. Lundberg, Edina, MN (US)

(21) Appl. No.: 19/346,104

(22) Filed: Sep. 30, 2025

Related U.S. Application Data
(60) Provisional application No. 63/701,490, filed on Sep. 30, 2024.

(51) Int. Cl. G06Q 10/0631; G06Q 10/0633

(52) U.S. Cl. CPC G06Q 10/06316; G06Q 10/0633

(57) ABSTRACT

Various embodiments provide systems and methods for multifactor workflow prioritization. One such embodiment is a computer-implemented method for recommending a next docketing requirement to work on. This method includes maintaining a database of docketed items, wherein each docketing requirement having a due date and at least one of a complexity factor, a time factor, and a priority factor associated with it. This embodiment further includes receiving a request for a recommendation on a next docketing requirement to work on and identifying outstanding docketing requirements in the database that need action. The method next ranks the identified docketing requirements based on at least one of the factors and presents at least one of the ranked docketing requirements as a recommendation on a next to be completed.

### CLAIM FOR PRIORITY

This application claims the benefit of priority under 35 U.S.C. § 119(e) to U.S. Provisional Patent Application Serial No. 63/701,490, filed on September 30, 2024, which is incorporated by reference herein in its entirety.

### TECHNICAL FIELD

Embodiments described herein generally relate to an electronic docketing system, and more specifically, to an electronic docketing system that provides prioritized recommendations to optimize workflow.

### BACKGROUND

Intellectual property (IP) portfolios monitored by companies and law firms often include large numbers of issued patents, pending patent applications, trademarks, copyrights, and other IP assets. Managing such portfolios requires tracking numerous deadlines, filings, and other docketing events to ensure IP rights are protected. Typically, IP management systems are utilized to assist with docketing tasks. IP management systems are often referred to as docketing systems.

Conventional IP management systems maintain databases of docketed items such as pending actions before the United States Patent and Trademark Office (USPTO) and other governmental offices involved in intellectual property rights filing, examination, and registration worldwide. Each docketed item is associated with a due date for taking action. For patent applications, common docketed items include office action responses, filing new applications, payment of issuance fees, annuity payments, and other required responses and filings. Trademarks have similar deadlines for responses, statements of use, renewals, and more.

### SUMMARY OF THE DISCLOSURE

A method for recommending a next docketing requirement to work on, the method comprising: maintaining a database of docketing requirements, wherein each docketing requirement has a due date and at least one of a complexity factor, a time factor, and a priority factor associated with it; receiving a request for a recommendation of at least one next docketing requirement to work on; identifying outstanding docketing requirements in the database that need action; ranking the identified docketing requirements based on the at least one factor; and presenting at least one of the ranked docketing requirements as a recommendation of what to work on next.

A system for recommending a next docketing requirement to work on may include: a database storing docketing requirements, each docketing requirement having a due date and at least one of a complexity factor, a time factor, and a priority factor associated with it; a processor configured to: receive a request for a recommendation of at least one next docketing requirement to work on; identify outstanding docketing requirements needing action; rank identified docketing requirements based on the at least one factor; and present at least one of the ranked docketing requirements as a recommendation on what to work on next.

A non-transitory computer-readable medium may store instructions that, when executed by a processor, cause the processor to perform a method for recommending a next docketing requirement to work on, the method may include: maintaining a database of docketing requirements, each docketing requirement having a due date and at least one of a complexity factor, a time factor, and a priority factor associated with it; receiving a request for a recommendation of at least one next docketing requirement to work on; identifying outstanding docketing requirements in the database needing action; ranking identified docketing requirements based on the at least one factor; and presenting at least one of the ranked docketing requirements as a recommendation on what to work on next.

A method for prioritizing outstanding legal docketing requirements, the method comprising: accessing a database of docketing requirements, each having a due date and at least one prioritization factor; identifying a set of outstanding docketing requirements needing action based on user criteria; ranking the set of outstanding docketing requirements based on due dates and the at least one prioritization factor; and providing one or more of the highest ranked docketing requirements as a recommendation on what to work on next.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example but not way of limitation, various embodiments discussed in the present document.

FIG. 1 is a block diagram of an automated docketing system in an example.

FIG. 2 is schematic diagram of sources of data used in system for multifactor workflow prioritization in an example.

FIG. 3 is a schematic diagram of a multifactor workflow prioritization system.

FIG. 4 is a flow chart depicting a general process for creating a prioritized multifactor workflow.

FIG. 5 depicts a schematic of a database containing a docketing requirement.

FIG. 6 is a flow chart depicting a process for creating a prioritized multifactor workflow, in an example.

FIG. 7 illustrates a block diagram of an example computing machine upon which any one or more of the techniques or methodologies discussed herein may be implemented.

### DETAILED DESCRIPTION

The present disclosure describes, among other things, a multifactor workflow prioritization tool and associated methods. The multifactor workflow prioritization tool may be used in conjunction with an automated or semi-automated system to provide a user with a recommended workflow that is customized based on various factors and the user’s request.

Discussed herein is a method for determining which docketing requirements should be prioritized at a given time based on several factors. The method automates the process of weighing factors such as the complexity, time available, and deadline, for example, in determining what work should be prioritized.

A recommendation database is maintained that may be based on the occurrence of an event like the issuance of a rejection by the PTO, or on legal deadlines based on statutory filing deadlines like the deadline to file a foreign patent application claiming priority to an original US patent application, for example. In addition to a due date, each docketed requirement stored in the recommendation database has one or more factors associated with it such as a complexity factor, a time factor, and a priority factor, and an extension expense factor.

A user may request recommendation(s) on what to work on next generally, or in view of user input such as the amount of time available to work. For example, a user may have one hour at the end of the day or may have an unconstrained period of time to work.

Once a user has requested a recommendation, the system may identify outstanding items on the user’s docket in need of action. Outstanding docketing requirements may be filtered by whether they have been assigned to the requesting user or to the requesting user’s role. Outstanding docketing requirements may also be identified without regard to the requesting user.

A filter will subsequently be applied to the identified outstanding docketing requirements. The filter may be a user default, one of a set of filters offered to users, or as specified by the user on an ad hoc basis.

The system may query one or more databases to determine if the filtered docketing requirements have been completed. If they have, the items may be removed from the database. Querying a database may include scraping public databases such as the USPTO database. Other databases may be queried as well such as a docketing system (IP Management System), or other system where data representative of completed docketing requirements is stored.

Once the identified outstanding docketing requirements have been filtered, they may be ranked based on any factors such as complexity, time, priority, or others.

As used herein, “electronic communication” refers to an electronic message or a method of exchanging messages between people using electronic devices.

As used herein, “template” may include a preset format for a document or file, used so that the format does not have to be recreated each time it is used. In some cases, a template may include one or more fields to be filled out.

As used herein, “application” or “program” may include a program or piece of software designed and written to fulfill a particular purpose of the user, such as a database application.

As used herein, “unstructured text” or “unstructured data” refers to data that is not organized in a standard format, for example, text in the body of an electronic communication.

As used herein, “structured data” refers to data that is organized in a standard format such that a recipient may read the data and institute an automated computing system action without human interpretation of the data.

As used herein, “scraping,” “web scraping,” “data scraping,” or “web crawling,” may refer to automatically mining or collecting data or information, such as from a database or from the internet.

As used herein, “file” or “matter” may refer to a particular project, enterprise, or undertaking being worked on by an individual or a collaborative group, planned and designed to achieve a particular aim.

As used herein, “official record,” or “file history,” may refer to data about a file or matter denoting evidence about past events or tasks within that file or matter, such as an electronic record of previous events in the file or matter. An “official record” may be stored with and maintained by an overseeing agency or organization, such as a governmental organization.

As used herein, “database,” may refer to a structured set of data, such as held in a computer or on the internet, that may be accessible in various ways.

As used herein, “deadline” refers to a target completion date. Deadlines may be set internally, externally, by a third party, or by a governmental agency.

As used herein, “extension” refers to an extension or postponement of a deadline. For example, an extension may be movement of a deadline date to a later time, for the payment of a fee with a governmental entity.

As used herein, “workflow” refers to a prioritized list of docketing requirements or tasks recommended to a user for completion.

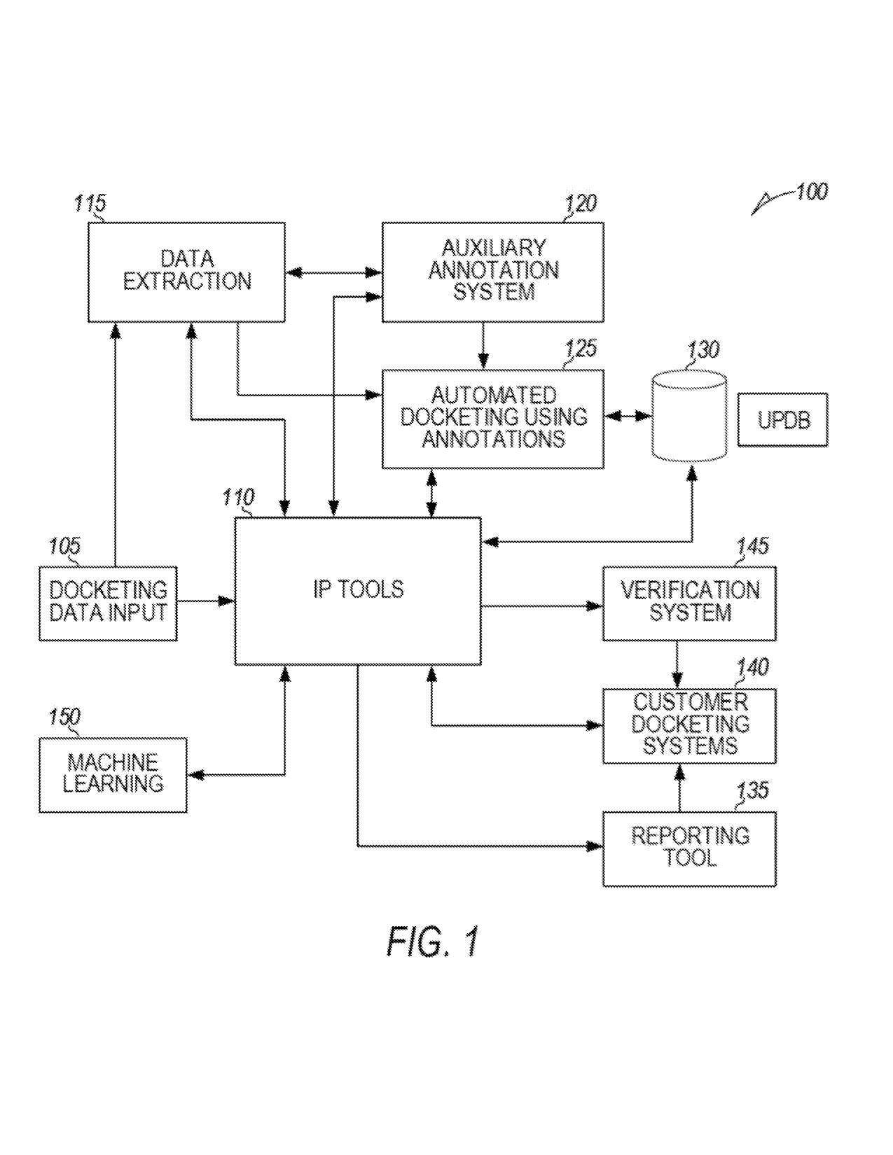

FIG. 1 is a block diagram of a docketing system 100 in an example. The docketing system 100 may be automated or semi-automated. The docketing system 100 may include docketing data input 105, docketing manager system 110, data extraction system 115, Auxiliary Annotation System 120, automated docketing tool 125, Universal Procedures Database (UPDB) 130, reporting tool 135, customer docketing system 140, verification system 145, and machine learning model system 150.

The docketing system 100 may receive documents from third party sources including third party docketing systems and/or customer data as docketing data input 105. The docketing manager system 110 may process the received documents to provide to the customer docketing system 140 and prepare the documents for data extraction by the data extraction system 115 as needed.

The data extraction system 115 may perform Optical Character Recognition (OCR) on the received documents from the docketing manager system 110 to extract unstructured data, read checkboxes, extract lists, and identify documents where possible, including official records and file histories. The docketing manager system 110 may also integrate with the UPDB 130 to provide automated docketing by an automated docketing tool 125 that processes received documents based on the additional annotations added to the documents based on the complex data extraction performed by the Auxiliary Annotation System (AAS) 120.

The AAS 120 may further identify the received documents without using an OCR. To manage this process, the docketing manager system 110 may receive frequent updates of docketing procedure rules including configuration data and updates the UPDB 130 with universal procedure codes (UPCs) as appropriate. The UPCs may be used in conjunction with customer specific codes, checklists, and templates. The rules may specify how to fill in the templates and how to complete customer-specific procedures such as how to docket documents into the customer docketing system 140, for example. The template may be filled out by pulling in attributes from the annotations in a document.

The AAS 120 may be an integrated or separate system that works with the data extraction system 115 and the docketing manager system 110. The AAS 120 may be used to sort unstructured data, such as data in the docketing manager system 110, and apply annotations, tags, or labels to that data, such as prior to moving that data to automated docketing tool 125. The AAS 120 may be used to annotate data extracted by the data extraction system 115. Data that may be annotated includes the type of rejections (or lack thereof), the number of cited references, the length of cited references, the length of an office action, whether it is the first office action received, the presence of a Rule 105 Request for Information, or the presence of allowed subject matter, for example.

In some cases, machine learning techniques may be used to generate annotations. For example, a database of past documents that have been identified may be provided by the docketing manager system 110 and used as a data warehouse to train and improve machine learning models by creating a training set for the machine learning model. Over time, the machine learning model system 150 may learn which Patent and Trademark Office (PTO) IDs to use for which documents, which document in a bundle of documents may be used to characterize the bundle, and may provide predicted PTO IDs for the received documents containing unstructured text. The machine learning model system 150 may also establish rule engine prediction capabilities for received documents that test the classifications.

The docketing manager system 110 may receive or intake electronic communications, documents, and docketing data from several different sources of docketing data input 105, validate the docketing requirements against entries in a customer docketing system 140, and communicate those documents to the customer docketing system 140 via a unified interface. The docketing manager system 110 may also route documents and associated docketing data through the data extraction system 115 and the AAS 120 and organize the returned metadata and annotations. The docketing manager system 110 thus may provide a breakout between the metadata and the document text.

The docketing manager system 110 may also keep records, including official records and file histories, and communicate with third-party application programming interfaces (APIs) to push the docketing data and documents automatically where allowed. Otherwise, the docketing manager system 110 may present the documents to human docketers to docket. The docketing manager system 110 may also issue reports upon request.

The docketing manager system 110 may be integrated with an existing docketing system (e.g., FOUNDATIONIP®), semi-integrated (e.g., CPI, ANAQUA®, etc.), may provide a virtual host that does not talk at all to the existing docketing system (e.g., IP Manager, MEMOTECH™), or may provide outputs in spreadsheet form for use by a docketing administrator to update the customer docketing system 140.

If the docketing manager system 110 and the customer docketing system 140 are not integrated, the data output of docketing system 100 may be presented to a human docketer for manual entry. For example, the human docketer may implement macros that interface with the customer docketing system 140 to populate the received data into the customer docketing system 140.

On the other hand, if the docketing manager system 110 and the customer docketing system 140 are integrated or semi-integrated, the data output may be processed to determine if any data is missing to automate the docketing process. If anything is missing, the human docketer may add that information before the automated docketing process may proceed further or the data may be auto-populated and mapped to the template from the UPDB 130.

The docketing system 100 may also perform several post-docketing actions, such as sending docketing reports/details to a verification system 145 that use a set of rules to verify proper docketing in a host system. The verification system 145 may verify that the data is correctly added to the customer docketing system 140. For example, the verification system 145 may pull data from the AAS 120, the docketing manager system 110, and the customer docketing system 140 to compare what is present to what is expected to be present in the respective systems.

The docketing system 100 may also provide automated “report out” electronic notifications to customers by implementing a reporting tool 135 that specifies docketing actions based on UPDB template configurations. The reporting tool 135 may also provide completed docketing reports to customers either directly or via the customer docketing system 140.

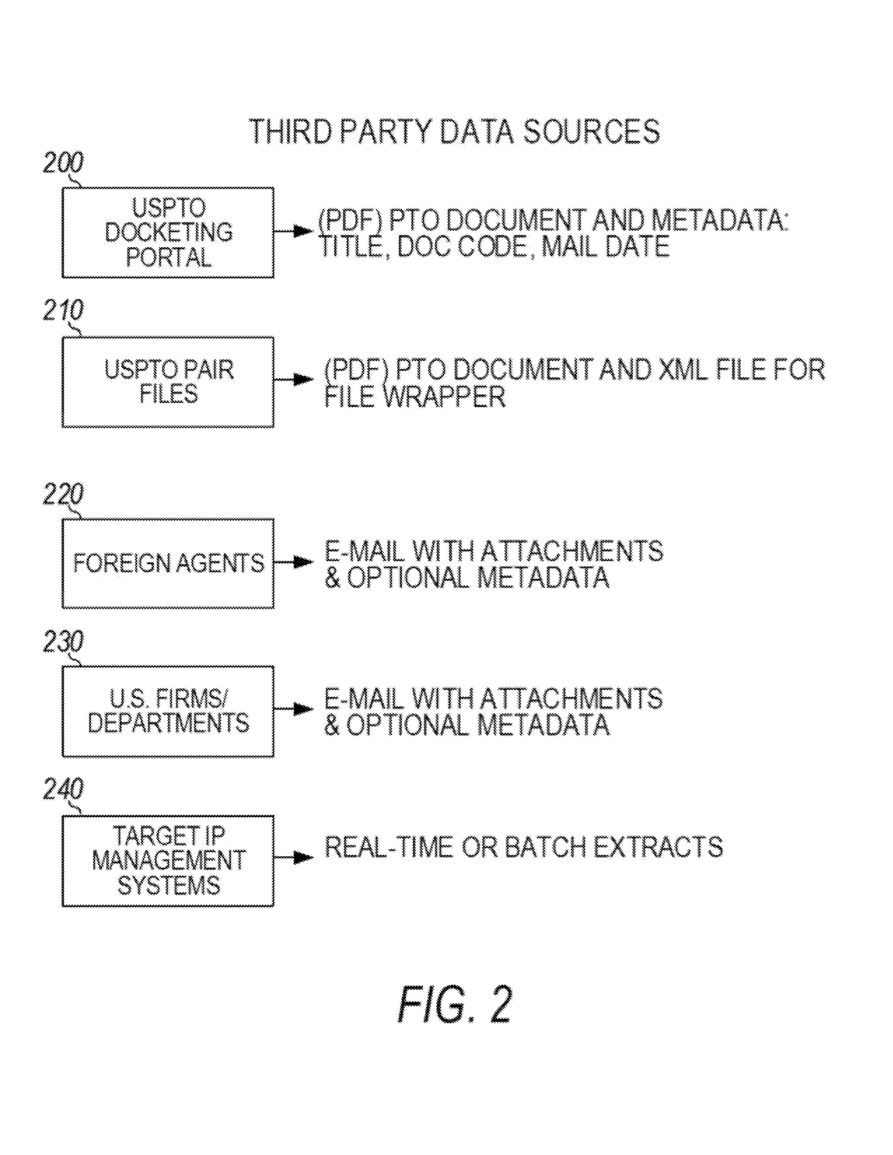

FIG. 2 illustrates sample third-party data sources that provide data input for a data interchange system. As illustrated in FIG. 2, the third-party data sources may include a national patent or trademark office (PTO) docketing portal 200, which provides documents from the PTO in portable document format (PDF) and includes metadata identifying the title, document code, and mail date for the corresponding document. The third-party data sources may further include PTO PAIR extensible markup language (XML) files 210, which provide documents from the PTO in PDF and includes an XML file for patent or trademark file wrappers. The third-party data sources may also include foreign agents 220 who provide electronic communications with attachments and optional metadata.

Foreign agents 220 may also provide hard copy documents that may be scanned for data entry. Similarly, law firms and/or corporate law departments 230 may provide electronic communications with attachments and optional metadata as well as hard copy documents that may be scanned for data entry. Also, third-party docketing systems 240 may provide real-time or batch extracts of data for entry into a docketing management system.

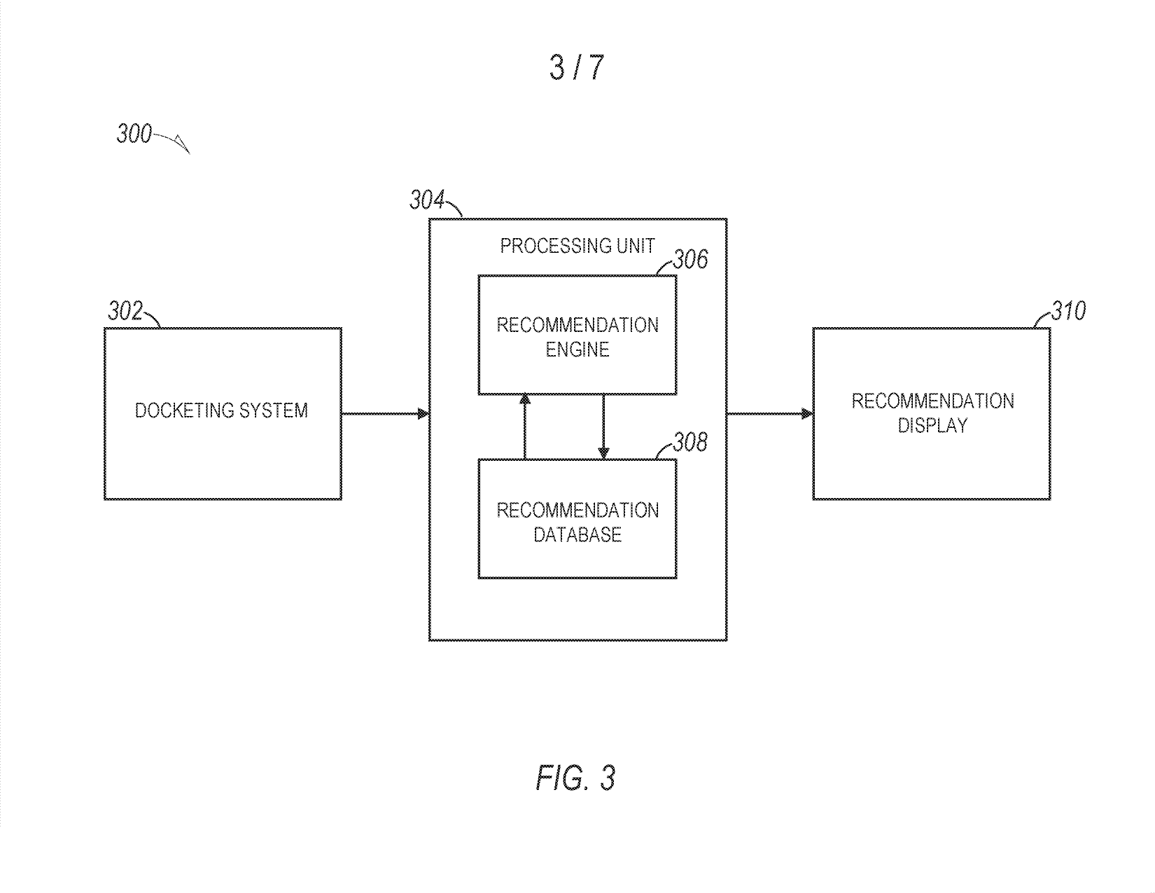

FIG. 3 is a schematic diagram of a multifactor workflow prioritization system including its components. The system may include, for example, docketing system 302, a processing unit 304, a recommendation engine 306, a recommendation database 308, and a recommendation display 310.

The docketing system 302 may be an automated or semi-automated docketing system, such as the docketing system discussed above with reference to FIG. 1. The docketing system may use an AAS 120 to sort data, such as data in the docketing manager system 110, and apply annotations, tags, or labels to that data.

Processing unit 304 may include a recommendation engine 306 and a recommendation database 308. The processing unit 304 may transform and filter docketing requirements from external databases used in docketing system 302 to create a list of one or more ranked docketing requirements for presentation to a user.

Recommendation engine 306 receives docketing requirements having a due date from the docketing system 302. The recommendation engine analyzes the docketing requirements for in order to determine one or more associated factors such as complexity, time, or priority.

The recommendation engine 306 may additionally receive annotations, tags, or labels from the docketing system 302 which were applied by the AAS 120. The recommendation engine may also use the annotations, tags, or labels to determine one or more factors associated with each docketing requirement.

Annotations, tags, or labels may include information regarding the docketing requirement such as type of rejections (or lack thereof), number of cited references, length of cited references, length of an office action, whether it a first office action, presence of a Rule 105 Request for Information, or presence of allowed subject matter, for example.

The recommendation engine 306 may also cross-reference docketing system 302 to determine whether a docketing requirement has been completed. If a docketing requirement has been completed, it will be removed from the recommendation database 308.

Once the recommendation engine 306 has completed analysis and determined the one or more associated factors, the docketing requirements are filtered and ranked for presentation to a user in the recommendation display 310. The docketing requirements with the one or more associated factors are stored in recommendation database 308.

Recommendation database 308 stores docketing requirements received from the docketing system 302 and analyzed, filtered, and ranked by recommendation engine 306.

Once the recommendation engine 306 has completed analyzing, filtering, ranking, and storing the docketing requirements in the recommendation database 308, processing unit 304 may send the ranked docketing requirements to recommendation display 310 for presentation to the user.

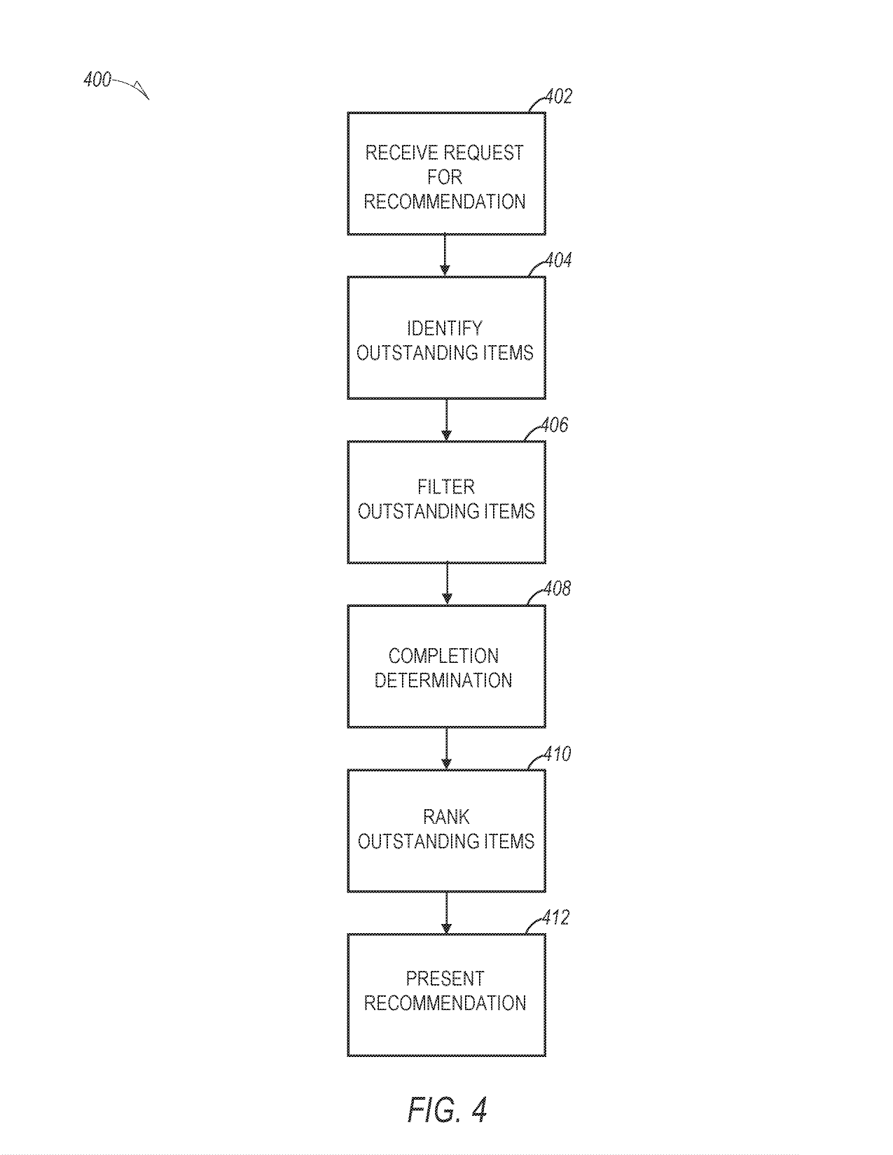

FIG. 4 is a flow chart depicting a general process 400 of creating a prioritized multifactor workflow.

At operation 402, a user may request that the system recommend a prioritized workflow. The user may want to know what items should be worked on next or what items should be worked on in view of user input such as the amount of time available to work, an hour at the end of the day, or an unconstrained period.

For example, a user may specify that they have one hour to work and request that the system recommend items that should be prioritized during that time, according to various factors.

The various factors to be considered may vary based on the user’s request and may be informed based on any number of attributes associated with the docketing requirement. For example, possible attributes that may inform the determination of factors include due date, document type, time required to prepare the document, antecedent basis error count, file history, number of references, attorney docket number, number of extensions taken, number of pending claims, number of allowed claims, type of rejection, examiner difficulty, art unit, and available next steps.

At operation 404, the system may query a database within the docketing system 302 to identify one or more outstanding docketing requirements which may need to be addressed. The system will identify a docketing requirement as needing to be addressed if there is a due date attached to it.

The database being queried may contain docketing requirements that have one or more associated annotations, tags, or labels applied by the AAS 120. In an example, the system may query a database and receive outstanding docketing requirements containing annotations identifying that the requirement is an office action response, there are multiple rejections, and the office action is particularly long.

At operation 406, the recommendation engine 306 may filter the one or more outstanding docketing requirements. The filters may be based on whether the items are assigned to the requesting user, the role of the requesting user, the type of outstanding item, required actions for the outstanding item, with or without regard to the requesting user, or other filters.

The filters applied at operation 406 may be set as a user default, may be part of a set of filters offered to users or defined by a user, or as specified by the user on an ad hoc basis.

At operation 408, the system may query one or more databases to determine if the identified docketing requirements have been completed.

Should any identified docketing requirements be completed, the system may remove the completed items from the set of identified docketing requirements.

The one or more databases contained in the docketing system 302 being queried at operation 408 may include a United States Patent and Trademark Office (USPTO) database, a docketing system (such as an IP Management System), or another system where data representative of completed docketing requirements is stored. Querying a database in operation 408 may also include scraping databases available from the internet.

At operation 410, the identified docketing requirements are ranked by the recommendation engine 306 based on one or more factors.

Ranking the identified docketing requirements may involve the recommendation engine 306 analyzing annotations associated with the docketing requirements to determine the value of various factors. For example, a docketing requirement may contain annotations identifying that the requirement is an office action response, there are multiple rejections, and the office action is particularly long. In this example, the recommendation engine 306 may analyze these annotations and assign a higher value to factors such as time and complexity.

In an embodiment, the outstanding docketing requirements are ranked according only to due date with no other factors applied.

Ranking the identified docketing requirements may further include the recommendation engine 306 analyzing the user’s request made at operation 402. For example, a user may stipulate that they only have one hour to work in their request for a prioritized workflow. In response, the recommendation engine 306 may adjust the ranking of the docketing requirements to prioritize docketing requirements that will take less than an hour to complete.

At operation 412, at least one of the ranked docketing requirements are presented to the user as recommendations for workflow based on the user’s input and one or more factors.

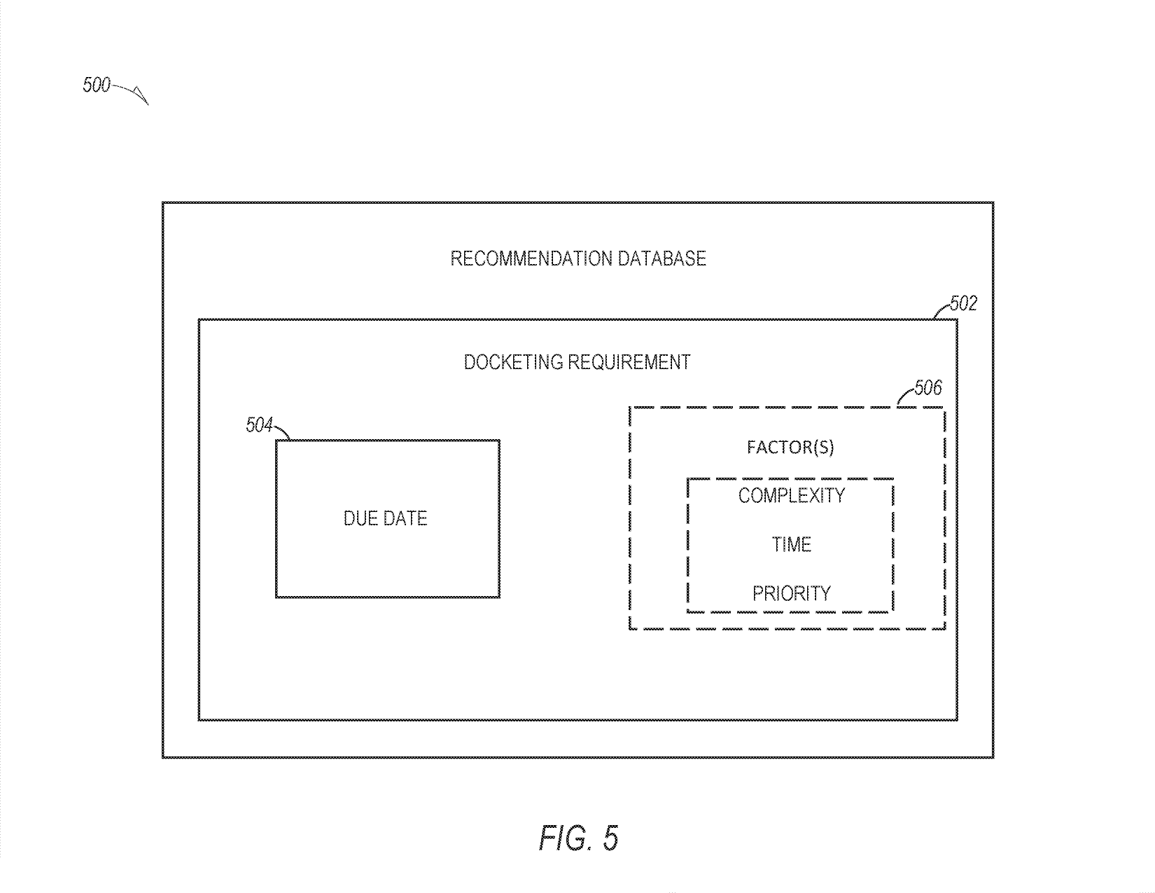

FIG. 5 depicts a schematic of recommendation database 500 containing a docketing requirement.

Stored within recommendation database 500 may be at least one docketing requirement 502 after being processed by the recommendation engine 306.

Docketing requirement 502 may be an office action response, a new patent application, issuance fee, annuity payment, or other required responses or filings.

Each docketing requirement 502 may contain at least a due date 504 and one or more factors 506. The possible one or more factors 506 associated with the docketing requirement may include a complexity factor, a time factor, a priority factor, and an extension expense factor, among others.

The due date 504 may be determined by a governmental office involved in intellectual property rights filing, examination, and registration worldwide. Example offices may be the USPTO or the European Patent Office (EPO).

The complexity factor estimates the complexity of the work to be completed on a docketing requirement. The complexity factor may be determined based on several different factors or based on a machine learning model. The factors used to determine complexity may be the type of rejections (or lack thereof), the number of cited references, the length of cited references, the length of an office action, whether it is the first office action received, the presence of a Rule 105 Request for Information, or the presence of allowed subject matter, for example.

The time factor estimates the amount of time required to complete the work on a docketing requirement. The time factor may be based on some or all of the same information as the complexity factor, and therefore may be encompassed into the complexity factor or be separate. The time factor may also be informed with a machine learning technique that compares the present docketing requirement with other docketing requirements that the user has worked on, and the amount of time billed for those other docketing requirements.

The priority factor will impact whether a docketing requirement is recommended to be worked on based on elements such as client priority, supervising attorney priority, and firm policy.

The extension expense factor may be based in whole or in part on the cost involved in obtaining an extension of a deadline to respond to a requirement.

However, none of the above individual factors are required, in an embodiment the workflow is prioritized based only on due dates.

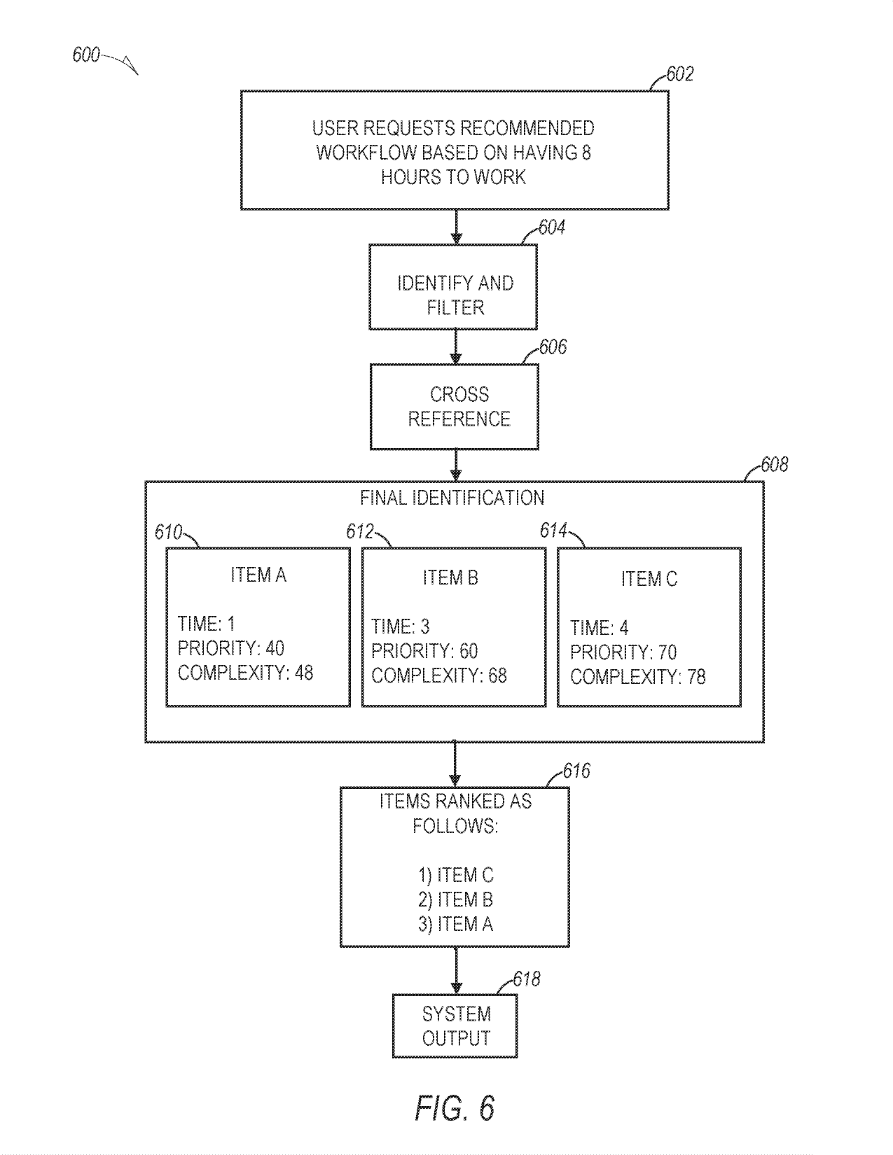

FIG. 6 depicts a typical method 600 for multifactor workflow prioritization.

At operation 602, a user may request a workflow based on having 8 hours to work.

At operation 604, the system may query a database located in docketing system 302 to identify docketing requirements or items having a due date. The recommendation engine may then filter any identified docketing requirements according to the process depicted above at operation 406.

At operation 606, the system may cross-reference the identified outstanding items with an external database located in or referenced by docketing system 302 such as one maintained by the USPTO to determine if any of the identified outstanding items have been filed already. The system may remove any identified outstanding items from the list of possible items to work on that have already been filed.

After identifying outstanding items, filtering outstanding items, and cross-referencing external databases, the system may have curated a final list of outstanding items for the user at operation 608.

Item A 610 is identified as having a time factor of 8, a priority factor of 40, and a complexity factor of 48, for example.

As an illustration, the time factor may be 1 which may represent that the item will take approximately one hour to complete.

As an illustration, the priority factor may be 40 out of 100. A priority factor of 100 may indicate that this item is of the highest priority due to an upcoming deadline, client preference, or firm policy. Whereas a priority factor of 0 may indicate that the item is of the lowest priority.

As an illustration, the complexity factor may be 48 out of 100, which may represent that the item is moderately complex to complete.

Similarly, item B 612 is identified as having a time factor of 3, a priority factor of 60, and a complexity factor of 68.

Similarly, at item C 614 is identified as having a time factor of 4, a priority factor of 70, and a complexity factor of 78.

Operation 608 may further include analyzing the user’s request that the workflow recommendation be based on having 8 hours to work. The system may further adjust the workflow recommendation based on the user’s request.

At operation 616, the system may complete ranking the items. As an example, items A-C may be ranked as follows; item C, item B, and then item A, based on an analysis of all factors and the user’s request. The number of factors may be more or less than depicted in method 600.

At operation 618 the system will output the ranked items as a recommended workflow to the requesting user.

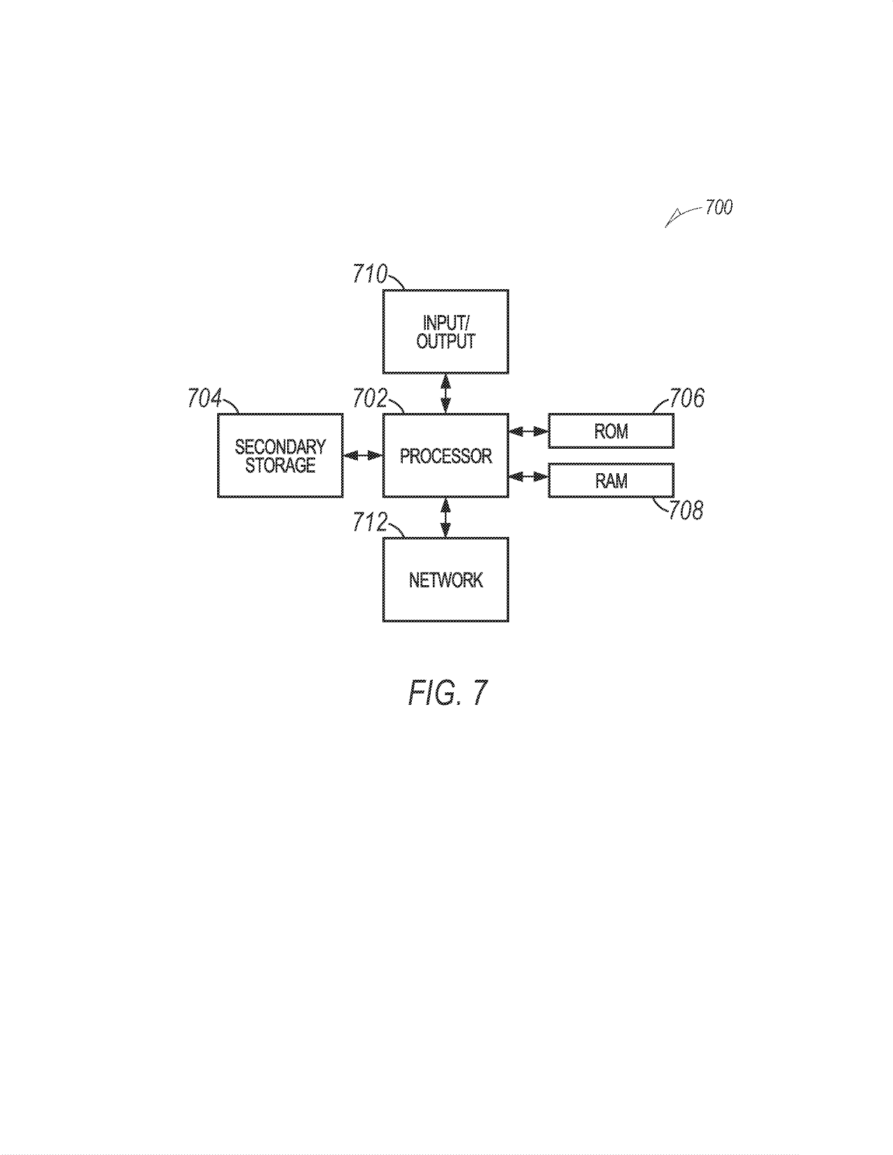

FIG. 7 is a block diagram of a typical, general-purpose computer 700 that may be programmed into a special purpose computer suitable for implementing one or more embodiments of the data interchange system disclosed herein. The data interchange system described above may be implemented on any general-purpose processing component, such as a computer with sufficient processing power, memory resources, and communications throughput capability to handle the necessary workload placed upon it. The computer 700 include a processor 702 (which may be referred to as a central processor unit or CPU) that is in communication with memory devices including secondary storage 704, read only memory (ROM) 706, random access memory (RAM) 708, input/output (I/O) devices 710, and network connectivity devices 712. The processor 702 may be implemented as one or more CPU chips or may be part of one or more application specific integrated circuits (ASICs).

The secondary storage 704 is typically comprised of one or more disk drives or tape drives and is used for non-volatile storage of data and as an over-flow data storage device if RAM 708 is not large enough to hold all working data. Secondary storage 704 may be used to store programs that are loaded into RAM 708 when such programs are selected for execution. The ROM 706 is used to store instructions and perhaps data that are read during program execution. ROM 706 is a non-volatile memory device that typically has a small memory capacity relative to the larger memory capacity of secondary storage 704. The RAM 708 is used to store volatile data and perhaps to store instructions. Access to both ROM 706 and RAM 708 is typically faster than to secondary storage 704.

The devices described herein may be configured to include computer-readable non-transitory media storing computer-readable instructions and one or more processors coupled to the memory, and when executing the computer-readable instructions configure the computer 700 to perform method steps and operations described above with reference to FIG. 3 to FIG. 6. The computer-readable non-transitory media includes all types of computer-readable media, including magnetic storage media, optical storage media, flash media, and solid-state storage media.

It should be further understood that software including one or more computer-executable instructions that facilitate processing and operations as described above with reference to any one or all of steps of the disclosure may be installed in and sold with one or more servers and/or one or more routers and/or one or more devices within consumer and/or producer domains consistent with the disclosure. Alternatively, the software may be obtained and loaded into one or more servers and/or one or more routers and/or one or more devices within consumer and/or producer domains consistent with the disclosure, including obtaining the software through physical medium or distribution system, including, for example, from a server owned by the software creator or from a server not owned but used by the software creator. The software may be stored on a server for distribution over the Internet, for example.

Also, it will be understood by one skilled in the art that this disclosure is not limited in its application to the details of construction and the arrangement of components set forth in the description or illustrated in the drawings. The embodiments herein are capable of other embodiments, and capable of being practiced or carried out in various ways. Also, it will be understood that the phraseology and terminology used herein is for the purpose of description and should not be regarded as limiting. The use of "including," "comprising," or "having" and variations thereof herein is meant to encompass the items listed thereafter and equivalents thereof as well as additional items. Unless limited otherwise, the terms "connected," "coupled," and "mounted," and variations thereof herein are used broadly and encompass direct and indirect connections, couplings, and mountings. In addition, the terms "connected" and "coupled" and variations thereof are not restricted to physical or mechanical connections or couplings. Further, terms such as up, down, bottom, and top are relative, and are employed to aid illustration, but are not limiting.

The components of the illustrative devices, systems and methods employed in accordance with the illustrated embodiments may be implemented, at least in part, in digital electronic circuitry, analog electronic circuitry, or in computer hardware, firmware, software, or in combinations of them. These components may be implemented, for example, as a computing program product such as a computing program, program code or computer instructions tangibly embodied in an information carrier, or in a machine-readable storage device, for execution by, or to control the operation of, data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. A computing program may be deployed to be executed on one computer or on multiple computers at one site or distributed across multiple sites and interconnected by a communication network. Also, functional programs, codes, and code segments for accomplishing the techniques described herein may be easily construed as within the scope of the present disclosure by programmers skilled in the art. Method steps associated with the illustrative embodiments may be performed by one or more programmable processors executing a computing program, code or instructions to perform functions (e.g., by operating on input data and/or generating an output). Method steps may also be performed by, and apparatus may be implemented as, special purpose logic circuitry, e.g., an FPGA (field programmable gate array) or an ASIC (application-specific integrated circuit), for example.

The various illustrative logical blocks, modules, and circuits described in connection with the embodiments disclosed herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computing program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computing program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory may be supplemented by or incorporated in special purpose logic circuitry.

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor may read information from, and write information to, the storage medium. In the alternative, the storage medium may be integral to the processor. In other words, the processor and the storage medium may reside in an integrated circuit or be implemented as discrete components.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory [EEPROM]), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium, or combination of multiple media, that is capable of storing instructions for execution by one or more processors, such that the instructions, when executed by one or more processors cause the one or more processors to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” as used herein excludes signals per se.

What is claimed is:

1. A computer-implemented method for recommending a next docketing requirement to work on, the method comprising:
maintaining a database of docketing requirements, wherein each docketing requirement has a due date and at least one of a complexity factor, a time factor, and a priority factor associated with it;
receiving a request for a recommendation of at least one next docketing requirement to work on;
identifying outstanding docketing requirements in the database that need action;
ranking the identified docketing requirements based on the at least one factor; and
presenting at least one of the ranked docketing requirements as a recommendation of what to work on next.

2. The computer-implemented method of claim 1, wherein the complexity factor estimates complexity of needed work on the docketing requirement, the time factor estimates an amount of time to complete work on the docketing requirement, and the priority factor impacts priority of the docketing requirement.

3. The computer-implemented method of claim 2, wherein the complexity factor is determined based on one or more of:
a type of rejection,
a number of cited references,
a length of cited references,
a length of an office action,
whether it is a first office action,
presence of a Rule 105 Request for Information, and
presence of allowable subject matter.

4. The computer-implemented method of claim 2, wherein the time factor is informed by a machine learning technique that compares the docketing requirement to other docketing requirements previously worked on and respective amounts of time billed.

5. The computer-implemented method of claim 1, wherein identifying outstanding docketing requirements comprises filtering docketing requirements by at least one of a requesting user, a role of the requesting user, or at least one type of docketing requirement.

6. The computer-implemented method of claim 1, further comprising querying at least one database to determine if any of the identified docketing requirements have been completed and removing all completed items.

7. The computer-implemented method of claim 6, wherein the at least one database comprises a USPTO database, a docketing system, or a system storing data indicating completed docketing requirements.

8. A system for recommending a next docketing requirement to work on, comprising:
a database storing docketing requirements, each docketing requirement having a due date and at least one of a complexity factor, a time factor, and a priority factor associated with it;
a processor configured to:
receive a request for a recommendation of at least one next docketing requirement to work on;
identify a set of outstanding docketing requirements needing action;
rank the outstanding docketing requirements based on the at least one factor; and
present at least one of the ranked outstanding docketing requirements as a recommendation on what to work on next.

9. The system of claim 8, wherein the complexity factor estimates complexity of needed work on the docketing requirement, the time factor estimates an amount of time to complete work on the docketing requirement, and the priority factor impacts priority of the docketing requirement.

10. The system of claim 9, wherein the processor is further configured to determine the complexity factor based on one or more of:
a type of rejection,
a number of cited references,
a length of cited references,
a length of an office action,
whether it is a first office action,
presence of a Rule 105 Request for Information, and
presence of allowed subject matter.

11. The system of claim 8, wherein the processor is configured to identify outstanding docketing requirements by filtering docketing requirements by at least one of a requesting user, a role of the requesting user, or at least one type of docketing requirement.

12. The system of claim 8, wherein the processor is further configured to query one or more databases to determine if any identified docketing requirements have been completed and remove all completed items from the set of outstanding docketing requirements before ranking.

13. A non-transitory computer-readable medium storing instructions that, when executed by a processor, cause the processor to perform a method for recommending a next docketing requirement to work on, the method comprising:
maintaining a database of docketing requirements, each docketing requirement having a due date and at least one of a complexity factor, a time factor, and a priority factor associated with it;
receiving a request for a recommendation of at least one next docketing requirement to work on;
identifying a set of outstanding docketing requirements needing action;
ranking the outstanding docketing requirements based on the at least one factor; and
presenting at least one of the ranked outstanding docketing requirements as a recommendation on what to work on next.

14. The non-transitory computer-readable medium of claim 13, wherein the complexity factor estimates complexity of needed work on the docketing requirement, the time factor estimates an amount of time to complete work on the docketing requirement, and the priority factor impacts priority of the docketing requirement.

15. The non-transitory computer-readable medium of claim 14, wherein the complexity factor is determined based on one or more of:
a type of rejection,
a number of cited references,
a length of cited references,
a length of an office action,
whether it is a first office action,
presence of a Rule 105 a Request for Information, and
presence of allowable subject matter.

16. The non-transitory computer-readable medium of claim 13, wherein identifying outstanding docketing requirements comprises filtering docketing requirements by at least one of a requesting user, a role of the requesting user, and at least one type of docketing requirement.

17. The non-transitory computer-readable medium of claim 13, wherein the method further comprises querying at least one database to determine if any identified docketing requirements have been completed and removing all completed items from the set before ranking.

18. A computer-implemented method for prioritizing outstanding legal docketing requirements, comprising:
accessing a database of docketing requirements, each having a due date and at least one prioritization factor;
identifying a set of outstanding docketing requirements needing action based on user criteria;
ranking the set of outstanding docketing requirements based on due dates and the at least one prioritization factor; and
providing one or more highest ranked docketing requirements as a recommendation on what to work on next.

19. The computer-implemented method of claim 18, wherein the at least one prioritization factor comprises one or more of:
complexity of work needed,
estimated time to complete the work, and
priority based on client, attorney, or firm policies.

20. The computer-implemented method of claim 18, further comprising querying external databases to determine if any of the set of outstanding docketing requirements have been completed and removing all completed items from the set before ranking.
